(19) United States
(12) Patent Application Publication
(10) Pub. No.: US 2004/0260610 A1
(43) Pub. Date: Dec. 23, 2004

(54) Sales managing method and system

(75) Inventor: Tsutomu Hasegawa, Kanagawa (JP)

Correspondence Address: FOLEY AND LARDNER, SUITE 500, 3000 K STREET NW, WASHINGTON, DC, 20007, US

(73) Assignee: NEC Infrontia Corporation

(21) Appl. No.: 10/868,820

(22) Filed: Jun. 17, 2004

(30) Foreign Application Priority Data
Jun. 18, 2003 (JP) 2003-173260

(51) Int. Cl. G06F 17/60

(52) U.S. Cl. 705/18

(57) ABSTRACT

When a person visiting the store comes to a store clerk, the store clerk has to utter predetermined service keywords, for instance, a keyword meaning “Welcome” used in the store. When a voice recognizing unit 13 recognizes this utterance from a microphone 11, a store PC 31 enables input terminals of a POS terminal 12 according to the result of recognition. Thus, the store clerks are formed to utter keywords and give satisfactory impression to the visitors, thus contributing to service improvement of the store in management of the utterance of predetermined service keywords by store clerks to persons visiting a store.

### BACKGROUND OF THE INVENTION

This application claims benefit of Japanese Patent Application No. 2003-173260 filed on Jun. 18, 2003, the contents of which are incorporated by the reference.

The present invention relates to sales managing method and system and, more particularly, to sales managing method and apparatus, which are applied to retail shops and like stores open to general public.

Small stores such as convenience stores, coffee shops, snack shops and gas station, which deal with various products and sell the same to general public visiting persons are becoming popularized. In such small stores, which have small numbers of employees for business, it is usual to introduce sales managing systems using POS systems or operational computers for such purposes as reducing the labor costs and permitting proper stock management.

Also, in such small stores it is an important factor for the success in the business of the store to give good impression to persons visiting the stores and get as many repeated visitors as possible, who visit the stores many times. To this end, it is primarily important to prepare high quality products (or hardware) and sell or provide these products at proper prices. However, the cleanliness of the store, prompt processes and kind and polite services (i.e., software) of store clerks, are also very important.

For this reason, store masters give store clerks educational training of making greeting such as “Irasshaimase” (i.e., “Welcome” in English) to persons visiting the stores and “Arigatoh gozaimashita” (i.e., “Thank you” in English) or “Matano goraiten wo omachishite orimasu” (i.e., “See you again” in English) to visited persons leaving the stores after the cashing process of charge payment. However, store clerks who have been given educational trailing a great deal, may not serve visiting persons by uttering the above service keywords such as “Irashaimase” (i.e., “Welcome” in English).

In the meantime, in the usual POS system, the operator inputs products data desired by a visited person are inputted by operating a keyword or depressing buttons or reading out a bar code indicative of the names and product numbers of the products with a bar code reader or the like. Such operation, however, is time-consuming and liable to operation errors. Accordingly, it has been proposed to provide the POS system with a voice recognizing unit for vocally inputting data quickly and accurately. (i.e., without input errors).

For example, a teller's machine or like electronic device has been proposed, in which a store clerk (i.e., operator) operating the POS system preliminarily registers his or her own voice by inputting the same and, at the time of operation, checks whether the inputted voice is identical with the registered voice, and in the case and only in the case of finding the identity the operation of the POS system is enabled (see Literature 1: Japanese Patent Laid-Open Showa 57-79542, for instance). As another example, a drive-through system or like POS terminal system has been proposed, which has a voice input means, a voice recognizing means, a display means, a voice output means, a printer means, etc., and permits vocal input operation (see Literature 2: Japanese Utility Model Laid-Open Heisei 3-104295, for instance). As a further example, sales managing system with voice recognizing function has been proposed, in which the number of times of generation of basic service word by a store clerk is recognized and counted (see Literature 3: Japanese Patent Laid-Open Heisei 7-37170, for instance).

The above POS terminal device in Literature 2 will be briefly described with reference to FIG. 3. This POS terminal device 201 is a drive-through system, in which a driver C in car 210 vocally orders products at counter from the inside of the car, and makes the payment and receives the products at a separate counter. As shown in 3(A), in this POS terminal device 201, a microphone 211, a display 212, a loud speaker 213, a printer 214 and a sensor 215 are provided on a surface of the car 210 on the side of the driver C, and further a connection port 216 for connection to a different device is provided. Also, as shown in FIG. 3(B), in a store 200 a plurality of POS terminals 210A and 201B, a site display 217 and a product delivery spot 218 are provided as well as products.

When the car 210 approaches the store 200, the sensor 215 detects this, and the POS terminal device 201 give necessary instructions vocally via the loudspeaker 213 to the driver C. Then, the driver C in the car 210 vocally orders desired products via one of the plurality of POS terminals 201A and 201B installed in the store 200. This voice is recognized via the microphone 211 by a voice recognizing unit (not shown) provided in the POS system in the store 200, and its content is displayed on the site display 217. The driver C in the car 210 confirms the ordered products from the display on the display 212, receives a print slit of product names, quantities and prices from the printer 214, drives the car in the direction of arrow in FIG. 3(B), then takes out the ordered products at the product delivery spot 218 and executes the cashing process. In this way, the driver C in the car 210 can order products and take out the ordered products and execute the cashing process without need of getting out from the car 210 or executing a complicated key input operation or the like.

The above sales managing system with voice recognizing function as disclosed in Literature 3, has the arrangement as shown in FIG. 4. Specifically, this sales managing system 300 with voice recognizing function is to be installed in a gasoline stand or the like, and comprises a host computer 310, a personal computer 312, an externally installed printer 314, a handy terminal 316, a car washing system 318, an oil head measuring system 320, a volume gauge 322, a prepaid card reader 324, a bar code reader 326, a customer display 328, a microphone 330 and a voice recognizing unit 332.

In this sales managing system 300 with voice recognizing function, a store clerk inputs the kinds, quantities, etc. of products desired by a visiting person by using a usual input means such as the handy terminal 316, and the voice recognizing unit 332, to which the store clerk inputs voice from the microphone 330 which is carried by him or her or provided in a nearby locality, has a function of recognizing basic voice words, such as “Irasshaimase” (i.e., “Welcome” in English), “Haioku desuka, regyurah desuka?” (i.e., “ High octane or regular?” in English), “Mantan ni shimasuka?” (i.e., “To full?” in English), “Sensha wa dohshimasuka?” (i.e., “Wash car?” in Engish), “Kahdodesuka, genkin desuka?” (i.e., “Card or cash?” in English), “Arigatoh gozaimashita.” (i.e., “Thank you” in English) and “Mata no goraiten wo omachishiteorimasu.” (i.e., “We wait your coming here again.” in English) uttered by the store clerk.

In such prior art sales managing method and system, the POS system has the voice recognizing system for supporting its operation with voice. However, the voice is not an essential requirement for the POS system operation. Therefore, a problem is posed that some store clerk serves a visiting person without uttering service words (or keywords) determined in the store, thus giving a bad impression to the visiting person or giving rise to an erroneous operation.

### SUMMARY OF THE INVENTION

The present invention was made in view of the above problem inherent in the prior art, and it has an object of providing a sales managing method and system, which can solve or greatly alleviate the above problem.

According to an aspect of the present invention, there is provided a sales managing method for a store or the like, which sells or provides products to persons visiting the store by using a POS system and executes a cashing process of settling the charges for the products, wherein: the POS system is held disabled unless it recognizes predetermined particular keywords uttered by a store clerk.

The particular keywords are at least one kind of service words predetermined in the store. Different kinds of keywords are used as particular keywords at the time of the start of input operation of the POS system and at the time of the cashing process. The particular keywords are “Welcome”, “Thank you” and/or “We wait your coming here again”. The number of times of utterance of the particular keywords is counted.

According to another aspect of the present invention, there is provided a sales managing system for selling or providing products to persons visiting the store by using a POS system and executing a cashing process for settling the charges for the products, wherein: the POS system includes a microphone and a voice recognizing unit, and the voice recognizing unit includes an operation control means for causing it to recognize at least one kind of predetermined service keywords uttered by a store clerk, and enables the operation of the POS system after its recognition of the keywords.

The operation control means of the POS system is a store personal computer and controls the input operations in input terminals of the POS system and/or the cashing process therein according to the result of recognition of keywords uttered by a store clerk. The store personal computer stores and manages the number of times of keyword recognition by the voice recognizing unit.

Other objects and features will be clarified from the following description with reference to attached drawings.

### BRIEF DESCRIPTION OF THE DRAWINGS

FIG. 1 is a block diagram showing an arrangement of a preferred embodiment of the sales managing method and apparatus according to the present invention;

FIG. 2 is an exemplified flow chart for explaining an operation of the sales managing apparatus shown in FIG. 1;

FIGS. 3(A) and 3(B) are a basic structure and a block diagram of a prior art drive through system; and

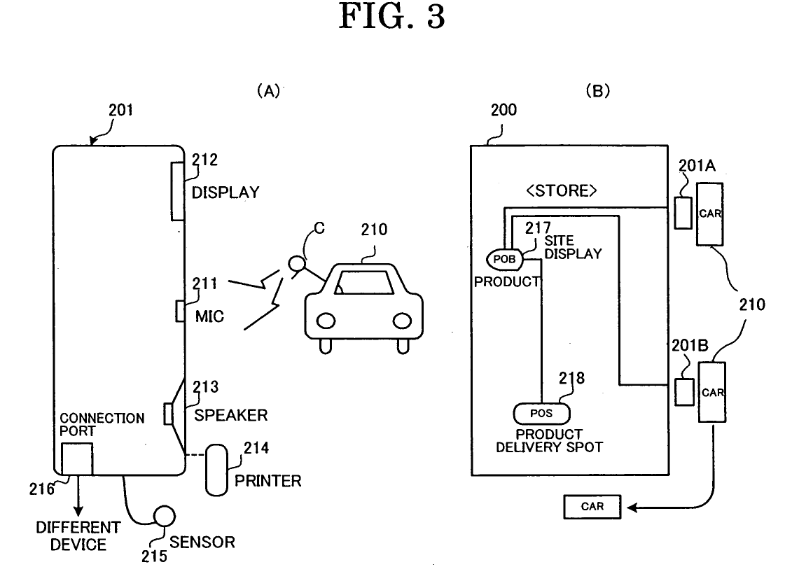

FIG. 4 is a block diagram showing a prior art sales managing system with voice recognizing function.

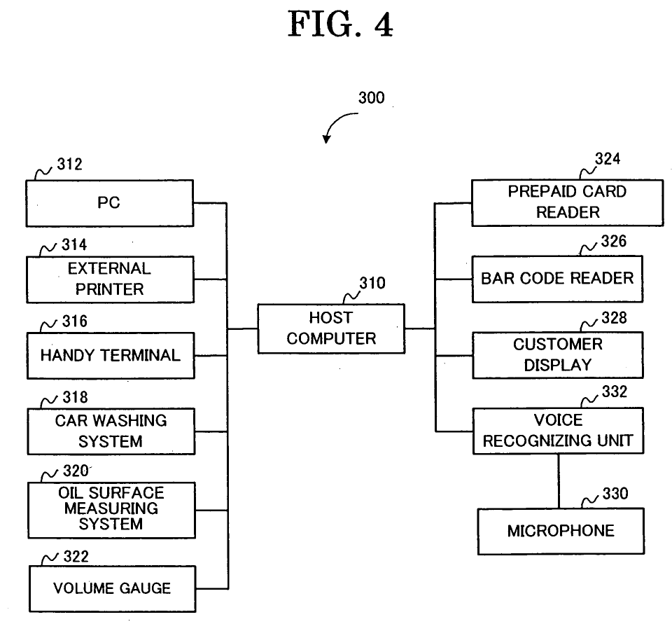

### PREFERRED EMBODIMENTS OF THE INVENTION

Preferred embodiments of the present invention will now be described with reference to the drawings.

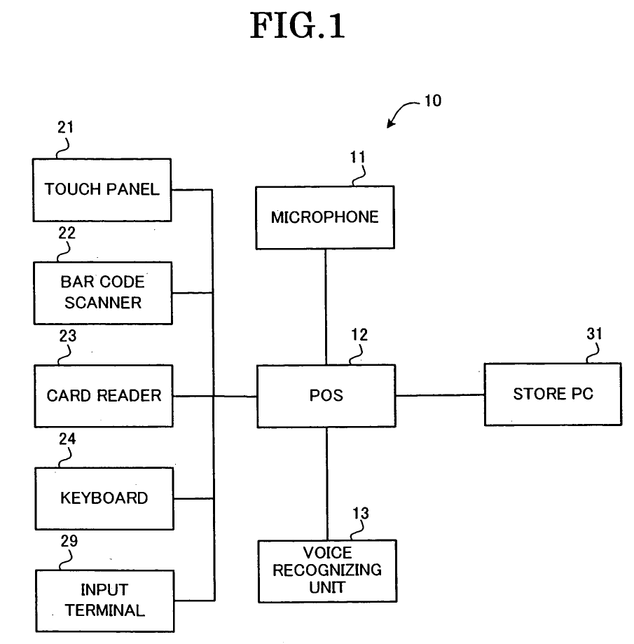

FIG. 1 is a block diagram showing the arrangement of a preferred embodiment of the sales managing system according to the present invention. This sales managing system 10 comprises a microphone 11, a POS terminal 12, a voice recognizing unit 13, a touch panel 21, a bar code scanner 22, a card reader 23, a keyboard 24, an input terminal 29 and a store PC (personal computer) 31.

In this sales managing system 10, as will be described later in details, the store PC 31 executes a process of summing up data from the POS terminal 12, the microphone 11 with store clerk's voice inputted thereto, the voice recognizing unit 13 and other data input terminals 21 to 29.

Referring to FIG. 1, when a store clerk utters a service voice (or keywords) provided in the store, for instance “Irasshaimase” (i.e., “Welcome” in English) toward the microphone 11, the voice recognizing unit 13 recognizes these keywords, and returns the result of recognition to the POS terminal 12. The POS terminal 12 receiving the result of recognition from the voice recognizing unit 13 enables the use of various data input terminals 21 to 29.

Also, a voice “Arigatoh gozaimashita” (i.e., “Thank you” in English) is used as keywords for disabling the data input to the input terminals 21 to 29. When the store clerk utters the keywords “Arigatoh gozaimashita” (i.e., “Thank you” in English) at the time of the end of a cashing process in the POS terminal 12, the POS terminal 12 thus disables the operation of inputting data to the input terminals 21 to 29. As an alternative arrangement, the data input to and output from the POS terminal 12 in the sales managing unit 10 may be automatically disabled upon the end of the cashing process in the POS terminal 12.

As described above, the voice recognizing unit 13 recognizes keywords such as “Irasshaimase” (i.e., “Welcome” in English) and “Arigatoh gozaimashita” (i.e., “Thank you” in English), which are provided in the store and uttered (i.e., used) at the time of service, and returns the result of recognition to the POS terminal 12 or the store PC 31. The store PC counts the number of times of utterance of these keywords, and numerically expresses the store clerk's service manner, thus assisting the service improvement of the store.

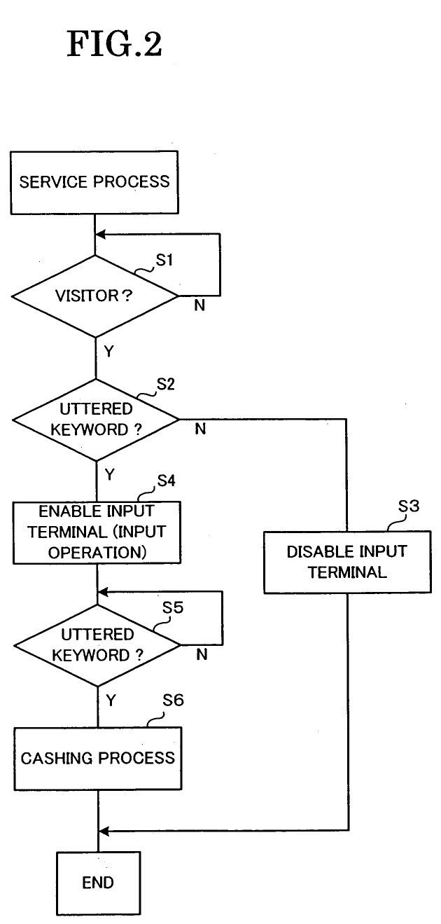

Now, the general operations and service process operation of the FIG. 1 sales managing system 10 according to the present invention will be described with reference to the flow chart shown in FIG. 2. In the first place, the system checks whether any visitor is present (step S1). When the system finds no visitor (i.e., “No” in step S1), it waits for visitor arrival. When the system finds a visitor (i.e., “Yes” in step S1), it checks for keywords (for instance, “Irashaimase” i.e., “Welcome” in English) uttered by a store clerk (step S2). When the system detects no keyword utterance (i.e., “No” in step S2), it disables (i.e., disables the operation of) the input terminals 21 to 29 in the POS terminal 12 (step S3). When the system detects store clerk's keyword utterance (i.e., “Yes” in step S2), it enables (i.e., enables the operation of) the input terminals 21 to 29 of the POS terminal 12, i.e., makes these terminals ready for the operation of inputting data (step S4).

Before the system executes a cashing operation of settling charges after an input operation executed when a visitor determines desired products, it checks whether the voice recognizing unit 13 has recognized the store clerk's utterance of a different kind of keywords (for instance “Arigatoh gozaimashita” (i.e. “Thank you” in English) (step S5). When the utterance of these keywords is not recognized, (i.e., “No” in step S5), the system holds the cashing process disabled until the utterance is recognized. When the utterance is recognized (i.e., “Yes” in step S5), the system enables the cashing process (step S6), thus bringing an end to the full routine.

The above keywords such as “Irashaimase” (i.e., “Welcome” in English) are by no means limitative, and it is possible to appropriately select polite voices such as “Konnichiwa” (i.e., “Good morning” or “Good afternoon” in English) (or “Konbanwa” (i.e., “Good evening” in English) and “Yohkoso irashaimase” (i.e., “Welcome sir (or madame or madmorsuelle)” in English) or such voices as “Rasshai” (i.e., “Come” in English) and “Maido” (i.e., “How are you.” in English) in dependence on the status of the store. Furthermore, in a system adapted to be installed in stores taking foreign countries or foreign visitors into considerations, such keywords as “Welcome” are appropriately preset.

As has been described in the foregoing, with the sales managing method and system according to the present invention the following pronounced practical effect are obtainable. First, the POS terminal, i.e., data input thereto, is held disabled unless particular keywords such as “Irasshaimase” (i.e., “Welcome” in English) and “Arigatoh gozaimashita” (i.e. “Thank you” in English) used in the service are uttered. Consequently, it is made inevitable for store clerks to utter predetermined keywords, and this provides for service improvement of the store. Also, counting and managing the number of times of utterance of such keywords are effective for the management of the service manner of store clerks.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

1. A sales managing method for a store or the like, which sells or provides products to persons visiting the store by using a POS system and executes a cashing process of settling the charges for the products, wherein:
the POS system is held disabled unless it recognizes predetermined particular keywords uttered by a store clerk.

2. The sales managing method according to claim 1, wherein the particular keywords are at least one kind of service words predetermined in the store.

3. The sales managing method according to one of claim 1, wherein different kinds of keywords are used as particular keywords at the time of the start of input operation of the POS system and at the time of the cashing process.

4. The sales managing method according to one of claim 1, wherein the particular keywords are “Welcome”, “Thank you” and/or “We wait your coming here again”.

5. The sales managing method according to one of claim 1 claims 1 to 4, wherein the number of times of utterance of the particular keywords is counted.

6. A sales managing system for selling or providing products to persons visiting the store by using a POS system and executing a cashing process for settling the charges for the products, wherein:
the POS system includes a microphone and a voice recognizing unit, and the voice recognizing unit includes an operation control means for causing it to recognize at least one kind of predetermined service keywords uttered by a store clerk, and enables the operation of the POS system after its recognition of the keywords.

7. The sales managing system according to claim 6, wherein the operation control means of the POS system is a store personal computer and controls the input operations in input terminals of the POS system and/or the cashing process therein according to the result of recognition of keywords uttered by a store clerk.

8. The sale managing system according to claim 7, wherein the store personal computer stores and manages the number of times of keyword recognition by the voice recognizing unit.

9. The sales managing method according to one of claim 2, wherein different kinds of keywords are used as particular keywords at the time of the start of input operation of the POS system and at the time of the cashing process.

10. The sales managing method according to one of claim 2, wherein the particular keywords are “Welcome”, “Thank you” and/or “We wait your coming here again”.

11. The sales managing method according to one of claim 2, wherein the number of times of utterance of the particular keywords is counted.

12. The sales managing method according to one of claim 3, wherein the number of times of utterance of the particular keywords is counted.

13. The sales managing method according to one of claim 4, wherein the number of times of utterance of the particular keywords is counted.

14. The sales managing method according to one of claim 9, wherein the number of times of utterance of the particular keywords is counted.

15. The sales managing method according to one of claim 10, wherein the number of times of utterance of the particular keywords is counted.
